(19) United States
(12) Patent Application Publication
(10) Pub. No.: US 2016/0124168 A1
(43) Pub. Date: May 5, 2016

(54) Pigtailed laser device based on spherical lens coupling

(71) Applicant: Elite Optoelectronics Co., LTD, Xi'An (CN)

(72) Inventor: Yanlin Wu, Xi'An (CN)

(73) Assignee: Elite Optoelectronics Co., LTD

(21) Appl. No.: 14/994,128

(22) Filed: Jan. 12, 2016

(30) Foreign Application Priority Data
Sep. 2, 2015 (CN) 201510556561.4

(51) Int. Cl. G02B 6/42

(52) U.S. Cl. CPC G02B 6/4285; G02B 6/4212

(57) ABSTRACT

A pigtailed laser device based on spherical lens coupling includes: a semiconductor laser device, and a focusing lens device connected to the semiconductor laser device; wherein the semiconductor laser device is coaxially mounted on a rear portion of a laser tube holder, a focusing lens is glued on a spherical lens holder and is mounted at a front portion of the laser tube holder without deviation; a connecting ring is externally mounted on the laser tube holder without deviation; a coupling adjusting mechanism is mounted at a rear portion of the laser tube holder, comprising an axle sleeve and an optical fiber fixing tube; the connecting ring is mounted on the laser tube holder by laser spot welding, the connecting ring is mounted on the axle sleeve by spot welding, and the axle sleeve is mounted on the optical fiber fixing tube by optical fiber spot gluing.

### CROSS REFERENCE OF RELATED APPLICATION

The present invention claims priority under 35 U.S.C. 119(a-d) to CN 201510556561.4, filed Sep. 02, 2015.

### BACKGROUND OF THE PRESENT INVENTION

1. Field of Invention

The present invention relates to a pigtailed laser device, and more particularly to a side-scattering pigtailed laser device with spherical lens as a semiconductor laser diode light source.

2. Description of Related Arts

Since the eighties of the last century, with the increasing practical level of semiconductor laser devices, pigtailed laser device with a semiconductor laser light source has been rapidly developed. Such devices have advantages such as high efficiency, long life, compact structure, good beam quality, and user-friendly interface. Therefore, research departments and manufacturers all over the world have developed pigtailed laser devices with a variety of performances, wherein in recent years, the pigtailed laser devices are widely used in various commercial applications. Conventionally, side-scattering optical fiber is the new development spot in the field of visualization technology, which has broad application and market in the fields of micro space lighting, laser decoration, and wearable device.

So far, for coupling semiconductor laser beam into an optical fiber, manufacturers mostly use fast axis collimation lens, aspheric lens or self-focusing lens, or an improved method based on the above coupling method.

The fast axis collimation lens, aspheric lens or self-focusing lens are able to couple laser beams, but will cause problems during side-scattering optical fiber coupling:

1) according to the prior art, focused spot of the aspheric lens or self-focusing lens is converged at one point, resulting uneven side light scattering during side-scattering optical fiber coupling;

2) according to the prior art, numerical aperture of the aspheric lens or self-focusing lens is small, which requires large installation size and high adjustment precision, and lowers production efficiency during side-scattering optical fiber coupling;

3) cost is high, wherein aspheric lens processing depends on ion permeability technology, whose material requirements are strict; the self-focusing lens processing depends on high-precision molds, which is difficult and expensive in equipments;

4) according to the prior art, for LD-pigtailed single-lens direct coupling with single self-focusing lens, LD beam requirements are high and size is longer, which is not conducive to device miniaturization; and

5) According to the prior art, for LD-pigtailed direct coupling with aspheric lens, at least two lenses are needed, wherein coaxial adjustment is difficult, and installation size thereof is not conducive to device miniaturization.

### SUMMARY OF THE PRESENT INVENTION

An object of the present invention is to provide a pigtailed laser device based on spherical lens coupling, which couples beams of a semiconductor laser device (LD) in a most optimized, cheapest and most reliable method for side-scattering.

Accordingly, in order to accomplish the above object, the present invention provides:

a pigtailed laser device based on spherical lens coupling, comprising: a laser tube holder being hollow; a semiconductor laser device coaxially mounted at an internal rear end of the laser tube holder, and a focusing lens device mounted at an internal front end of the laser tube holder; wherein the pigtailed laser device further comprises a connecting ring and a tail sealing tube, wherein the connecting ring is externally mounted on the laser tube holder without deviation, and partly extends out of a front end of the laser tube holder; the tail sealing tube is externally mounted on the connecting ring and partly extends out of the connecting ring; a pigtail is wrapped by an optical fiber protector, and then is inserted into the tail sealing tube, wherein the pigtail is mounted inside the pigtailed laser device by a coupling adjusting mechanism.

The focusing lens device comprises a focusing lens and a spherical lens holder, wherein the focusing lens is a spherical lens, and the spherical lens is made of optical glass; the spherical lens holder is a copper part; materials of the laser tube holder, the connecting ring, the tail sealing tube and the coupling adjusting mechanism are different from the spherical lens holder.

The spherical lens is glued on the spherical lens holder and is mounted on the front end of the laser tube holder without deviation.

The coupling adjusting mechanism comprises an axle sleeve and an optical fiber fixing tube, wherein a rear end of the axle sleeve presses against a front end of the connecting ring, and the optical fiber fixing tube is placed inside the axle sleeve.

The connecting ring is mounted on the laser tube holder by laser spot welding, the connecting ring is mounted on the axle sleeve by spot welding, and the axle sleeve is mounted on the optical fiber fixing tube by optical fiber spot gluing.

The pigtail is a side-scattering quartz optical fiber, and is mounted on the optical fiber fixing tube by epoxy resin.

An internal diameter of the axle sleeve cooperates with an external diameter of the optical fiber fixing tube without deviation, a left surface of the axle sleeve cooperates with a right surface of the connecting ring without deviation.

The pigtail flushes with a rear end of the optical fiber fixing tube and is mounted thereon by gluing, an end of the pigtail, which flushes with the optical fiber fixing tube, is polished and coated with an antireflection film.

A first step surface is externally arranged on the laser tube holder, the connecting ring is exactly mounted on the first step surface; a second step surface is externally arranged on the connecting ring, the tail sealing tube is exactly mounted on the second step surface, in such a manner that external surfaces of the laser tube holder, the connecting ring and the tail sealing tube flush with each other, and max external diameters and min internal diameters of the laser tube holder, the connecting ring and the tail sealing tube equal to each other.

An external diameter of the axle sleeve is larger than a min internal diameter of the connecting ring, an internal diameter of the axle sleeve is smaller than the min internal diameter of the connecting ring.

Compared with the prior art, the present invention at least has beneficial effects as follows. The present invention uses the spherical lens to replace a self-focusing lens or an aspheric coupling lens. Because of optical properties of the spherical lens, spherical aberration will be introduced during beam shaping, which has a certain homogenization effect on laser spots, and greatly improves a coupling effect of side visual large numerical aperture, thereby improving optical fiber side-scattering light homogenization, reducing a cost of a coupler and simplifying a coupler structure. In addition, because of utilization of the spherical lens holder, a thickness thereof effectively controls an optical front intercept of the spherical lens. Within visible light band, output numerical aperture is adjustable by adjusting the thickness of the spherical lens, which solves installation and pollution problems of the spherical lens and improves production efficiency.

### BRIEF DESCRIPTION OF THE DRAWINGS

These and other objectives, features, and advantages of the present invention will become apparent from the following detailed description, the accompanying drawings, and the appended claims.

FIG. 1 is a structural view of a pigtailed laser device based on spherical lens coupling according to the present invention.

FIG. 2 is an exploded view of the pigtailed laser device based on spherical lens coupling according to the present invention.

### DETAILED DESCRIPTION OF THE PREFERRED EMBODIMENT

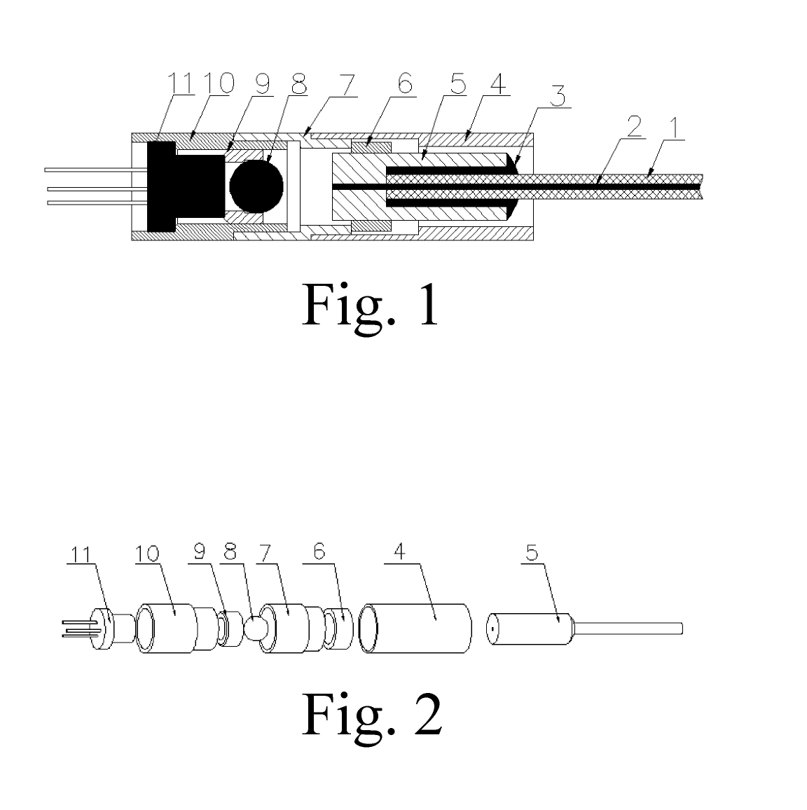

Referring to FIG. 1 of the drawings, a structural view of a pigtailed laser device based on spherical lens coupling according to the present invention is provided, which comprises: a transparent PVC optical fiber protector 1, a pigtail 2, epoxy resin 3, tail sealing tube 4, an optical fiber fixing tube 5, an axle sleeve 6, a connecting ring 7, a focusing lens 8, a spherical lens holder 9, a laser tube holder 10 and a semiconductor laser device 11.

According to the present invention, a pigtailed laser device based on spherical lens coupling is provided, comprising: a semiconductor laser device 11 for visible light, a focusing lens device (comprising a focusing lens 8 and a spherical lens holder 9) connected to the semiconductor laser device 11, and an optical fiber end face connected to the focusing lens device; wherein the semiconductor laser device 11 is coaxially mounted on a rear portion of a laser tube holder 10, the focusing lens 8 is glued on the spherical lens holder 9 and is mounted at a front portion of the laser tube holder 10 without deviation; a connecting ring 7 is externally mounted on the laser tube holder 10 without deviation; a coupling adjusting mechanism comprises an axle sleeve 6 and an optical fiber fixing tube 5 made of stainless steel; the connecting ring 7 is mounted on the laser tube holder 10 by laser spot welding, the connecting ring 7 is mounted on the axle sleeve 6 by spot welding, and the axle sleeve 6 is mounted on the optical fiber fixing tube 5 by optical fiber spot gluing; a pigtail 2 is a side-scattering quartz optical fiber, and is mounted on the optical fiber fixing tube 5 by epoxy resin.

The focusing lens 8 is a spherical lens, and the spherical lens is made of optical glass; the spherical lens holder 9 is a copper part; the laser tube holder 10, the connecting ring 7, the axle sleeve 6, the optical fiber fixing tube 5 and a tail sealing tube 4 are stainless steel parts.

The spherical lens holder 9 is mounted at a window end face of a laser diode, and a thickness of the spherical lens holder 9 is adjustable according to different coupling light beam wavelengths; an internal diameter of the axle sleeve 6 cooperates with an external diameter of the optical fiber fixing tube 5 without deviation, a left surface of the axle sleeve 6 cooperates with a right surface of the connecting ring 7 without deviation; the pigtail 2 flushes with a left end of the optical fiber fixing tube 5 and is mounted thereon by gluing, a left end face of the pigtail 2 is polished and coated with 450 nm, 520 nm and 635 nm antireflection films. During light transmission, the pigtail 2 scatters a part of the light into an external space through a wrapping layer, which is a side-scattering optical fiber.

Lasers from the semiconductor laser device 11 are visible lights with wavelengths of 450 nm, 520 nm and 635 nm. A laser fast axis divergence angle is generally between 30-45 degrees. The focusing lens 8 optically connected to the semiconductor laser device 11 shapes focuses irregular diverging beams emitted from the semiconductor laser device 11 is shaped and focused onto the side-scattering optical fiber of the pigtail.

According to the preferred embodiment, the spherical lens holder 9 has three effects: firstly, fixing the spherical lens, so as to simplify installation and clean thereof; secondly, adjusting optical coupling front intercept, so as to guarantee that the numerical aperture of the lens coupling is consistent in a range of visible light; finally, cooperating with the laser tube holder 10 without deviation, as so to ensure coaxially optical precision.

According to the preferred embodiment, the connecting ring 7, the axle sleeve 6 and the optical fiber fixing tube 5 are all made of 304 stainless steel, these three components form a tri-axial adjusting mechanism of an optical fiber coupler, wherein the right surface of the connecting ring 7 cooperates with the left surface of the axle sleeve 6 without deviation, the internal diameter of the axle sleeve 6 cooperates with the external diameter of the optical fiber fixing tube 5 without deviation. After an optimum coupling point is obtained by adjusting with a chuck, the three components are integrated by laser spot welding, wherein preferred laser welding parameters are 10 ms pulse width, pulse energy 20J per time, and repetition 1. The tail sealing tube 4 is a protector laser for a laser welding spot and the pigtail 2, which enhances product strength, and increase availability.

According to the present invention, due to replacing a self-focusing lens or an aspheric coupling lens with the spherical lens, coupling efficiency of side visual large numerical aperture optical fiber is improved, homogenized degree of optical fiber side-scattering light is improved, a cost the coupler is reduced, and a structure of the coupler is narrowed. Due to utilization of the spherical lens holder, a thickness thereof effectively controls the optical front intercept of the spherical lens. Within a visible light band, output numerical aperture is adjustable by finely adjusting the thickness of the spherical lens, which solves installation and pollution problems of the spherical lens and improves production efficiency. Due to utilization of the axle sleeve, the optical coupling adjustment is able to provide tri-axial cooperation without deviation, which is conducive to miniaturization, and provides high welding strength.

Compared with the prior art, the present invention has advantages as follows.

1) According to the present invention, the structure is compact, design is reasonable, assembly is simple, and the present invention is easy to achieve.

2) According to the present invention, due to replacing a self-focusing lens or an aspheric coupling lens with the spherical lens, problems of small spot at the coupling point and small numerical aperture are solved, and side-scattering effect of large core diameter large numerical aperture side-scattering optical fiber.

3) According to the present invention, due to replacing a self-focusing lens or an aspheric coupling lens with the spherical lens, coupling efficiency and practical effect are more outstanding, which saves raw materials cost of the product.

4) According to the present invention, a size of the side-scattering optical fiber coupler is extremely reduced to achieve more than 50 mW laser coupling power within D4×L15, which improves application range of the product.

5) According to the present invention, due to a tri-axial homodyne seamless adjustment method, production process is greatly simplified, manufacture process is easier to control, and a yield is increased.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pigtailed laser device based on spherical lens coupling, comprising: a laser tube holder (10) being hollow; a semiconductor laser device (11) coaxially mounted at an internal rear end of the laser tube holder (10), and a focusing lens device mounted at an internal front end of the laser tube holder (10); wherein the pigtailed laser device further comprises a connecting ring (7) and a tail sealing tube (4), wherein the connecting ring (7) is externally mounted on the laser tube holder (10) without deviation, and partly extends out of a front end of the laser tube holder (10); the tail sealing tube (4) is externally mounted on the connecting ring (7) and partly extends out of the connecting ring (7); a pigtail (2) is wrapped by an optical fiber protector (1), and then is inserted into the tail sealing tube (4), wherein the pigtail (2) is mounted inside the pigtailed laser device by a coupling adjusting mechanism.

2. The pigtailed laser device, as recited in claim 1, wherein the focusing lens device comprises a focusing lens (8) and a spherical lens holder (9), wherein the focusing lens (8) is a spherical lens, and the spherical lens is made of optical glass; the spherical lens holder (9) is a copper part; materials of the laser tube holder (10), the connecting ring (7), the tail sealing tube (4) and the coupling adjusting mechanism are different from the spherical lens holder (9).

3. The pigtailed laser device, as recited in claim 2, wherein the spherical lens is glued on the spherical lens holder (9) and is mounted on the front end of the laser tube holder (10) without deviation.

4. The pigtailed laser device, as recited in claim 1, wherein the coupling adjusting mechanism comprises an axle sleeve (6) and an optical fiber fixing tube (5), wherein a rear end of the axle sleeve (6) presses against a front end of the connecting ring (7), and the optical fiber fixing tube (5) is placed inside the axle sleeve (6).

5. The pigtailed laser device, as recited in claim 4, wherein the connecting ring (7) is mounted on the laser tube holder (10) by laser spot welding, the connecting ring (7) is mounted on the axle sleeve (6) by spot welding, and the axle sleeve (6) is mounted on the optical fiber fixing tube (5) by optical fiber spot gluing.

6. The pigtailed laser device, as recited in claim 4, wherein the pigtail (2) is a side-scattering quartz optical fiber, and is mounted on the optical fiber fixing tube (5) by epoxy resin.

7. The pigtailed laser device, as recited in claim 4, wherein an internal diameter of the axle sleeve (6) cooperates with an external diameter of the optical fiber fixing tube (5) without deviation, a left surface of the axle sleeve (6) cooperates with a right surface of the connecting ring (7) without deviation.

8. The pigtailed laser device, as recited in claim 4, wherein the pigtail (2) flushes with a rear end of the optical fiber fixing tube (5) and is mounted thereon by gluing, an end of the pigtail (2), which flushes with the optical fiber fixing tube (5), is polished and coated with an antireflection film.

9. The pigtailed laser device, as recited in claim 5, wherein the pigtail (2) flushes with the optical fiber fixing tube (5) and is mounted thereon by gluing, an end of the pigtail (2), which flushes with the optical fiber fixing tube (5), is polished and coated with an antireflection film.

10. The pigtailed laser device, as recited in claim 6, wherein the pigtail (2) flushes with the optical fiber fixing tube (5) and is mounted thereon by gluing, an end of the pigtail (2), which flushes with the optical fiber fixing tube (5), is polished and coated with an antireflection film.

11. The pigtailed laser device, as recited in claim 7, wherein the pigtail (2) flushes with the optical fiber fixing tube (5) and is mounted thereon by gluing, an end of the pigtail (2), which flushes with the optical fiber fixing tube (5), is polished and coated with an antireflection film.

12. The pigtailed laser device, as recited in claim 1, wherein a first step surface is externally arranged on the laser tube holder (10), the connecting ring (7) is exactly mounted on the first step surface; a second step surface is externally arranged on the connecting ring (7), the tail sealing tube (4) is exactly mounted on the second step surface, in such a manner that external surfaces of the laser tube holder (10), the connecting ring (7) and the tail sealing tube (4) flush with each other, and max external diameters and min internal diameters of the laser tube holder (10), the connecting ring (7) and the tail sealing tube (4) equal to each other.

13. The pigtailed laser device, as recited in claim 4, wherein an external diameter of the axle sleeve (6) is larger than a min internal diameter of the connecting ring (7), an internal diameter of the axle sleeve (6) is smaller than the min internal diameter of the connecting ring (7).
